(19) United States
(12) Patent Application Publication
(10) Pub. No.: US 2004/0173566 A1
(43) Pub. Date: Sep. 9, 2004

(54) Method for polymer removal after an etching process

(75) Inventors: Chih Yuan Huang, Hsinchu (TW); Cheng Shun Chen, Hsinchu (TW); Ling-Wuu Yang, Hsinchu (TW); Kuang-Chao Chen, Hsinchu (TW)

Correspondence Address: Finnegan, Henderson, Farabow,, Garrett & Dunner, L.L.P., 1300 I Street, N.W., Washington, DC, 20005-3315, US

(73) Assignee: Macronix International Co., Ltd.

(21) Appl. No.: 10/376,229

(22) Filed: Mar. 3, 2003

(51) Int. Cl. G09F 17/00

(52) U.S. Cl. 216/13

(57) ABSTRACT

A method of manufacturing a semiconductor device that includes providing a wafer substrate, providing an insulator over the wafer substrate; depositing a first layer over the insulator, forming a layer of dielectric material over the first silicon layer, depositing a second silicon layer over the layer of dielectric material, providing a photoresist layer over the second silicon layer, patterning and defining the photoresist layer, etching the second silicon layer, the layer of dielectric material, the first silicon layer and the insulator unmasked by the photoresist, removing the photoresist layer, and cleaning at least the etched first silicon layer with a mixture of deionized water and ozone gas.

### DESCRIPTION OF THE INVENTION

1. Field of the Invention

The invention relates in general to a method of fabricating a semiconductor device, and, more specifically, to a method of removing polymer after an etching process.

2. Background of the Invention

A memory device generally includes a first gate formed over a first dielectric layer, which is formed over a semiconductor substrate. In the case of a flash memory, the first gate is known as a floating gate, and the first dielectric layer is known as a tunneling oxide. A flash memory device also includes a control gate formed over the floating gate, and a second dielectric layer formed between the floating and control gates.

In the manufacturing process of a memory device, the gate is deposited, patterned and etched. However, the etching process often results in the formation of undesired polymeric materials that lies along the sidewalls of the etched gate. Those polymeric materials may lead to certain defects, such as random single bit data retention failure.

In the conventional semiconductor manufacturing process, a cleaning step generally follows the etching process. One conventional cleaning step is an RCA cleaning method developed by Werner Kern. The RCA clean is a two-step process that includes Standard Clean 1, referred to as SC-1, and Standard Clean 2, or SC-2. In the Standard Clean 1, the SC-1 solution is generally a 1:1:5 to 1:2:7 mixture of ammonium hydroxide, hydrogen peroxide, and deionized water. Standard Clean 2 uses a composition of hydrochloric acid, hydrogen peroxide, and deionized water. In addition to the RCA etch, another conventional cleaning solution that has been used to remove organic and metallic impurities is a mixture consisting of sulfuric acid and hydrogen peroxide.

However, while these above-mentioned conventional cleaning solutions can effectively remove various contaminants, they also undesirably etch the tunneling oxide, thereby degrading the integrity of the tunneling oxide. Such unintended tunneling oxide degradation impairs the reliability and long-term performance of the memory devices.

### SUMMARY OF THE INVENTION

In accordance with the invention, there is provided a method of manufacturing a semiconductor device that includes providing a wafer substrate, providing an insulator over the wafer substrate, depositing a first layer over the insulator, forming a layer of dielectric material over the first silicon layer, depositing a second silicon layer over the layer of dielectric material, providing a photoresist layer over the second silicon layer, patterning and defining the photoresist layer, etching the second silicon layer, the layer of dielectric material, the first silicon layer and the insulator unmasked by the photoresist, removing the photoresist layer, and cleaning at least the etched first silicon layer with a mixture of deionized water and ozone gas.

Also in accordance with the present invention, there is provided a method of manufacturing a semiconductor device that includes providing a layer of dielectric material, depositing a silicon layer over the layer of dielectric material, providing a photoresist layer over the silicon layer, patterning and defining the photoresist layer, etching the silicon layer and the dielectric layer unmasked by the photoresist, removing the photoresist layer, and cleaning with a mixture of deionized water and ozone gas.

In accordance with the present invention, there is additionally provided a method of manufacturing a semiconductor device that includes providing a wafer substrate, providing an insulator over the wafer substrate, depositing a silicon layer over the insulator, forming a layer of dielectric material over the silicon layer, providing a photoersist layer over the dielectric layer, patterning and defining the photoresist layer, etching the silicon layer and the insulator unmasked by the photoresist, removing the photoresist layer, and cleaning the etched silicon layer with a mixture of deionized water and ozone gas.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIGS. 1-3 are cross-sectional views of the fabrication steps consistent with one embodiment of the present invention; and

FIG. 4 is a chart comparing the polymer removal capability of using a Standard SC-2 cleaning treatment and a cleaning method consistent with one embodiment of the present invention.

### DESCRIPTION OF THE EMBODIMENTS

Reference will now be made in detail to the present embodiments of the invention, examples of which are illustrated in the accompanying drawings. Wherever possible, the same reference numbers will be used throughout the drawings to refer to the same or like parts.

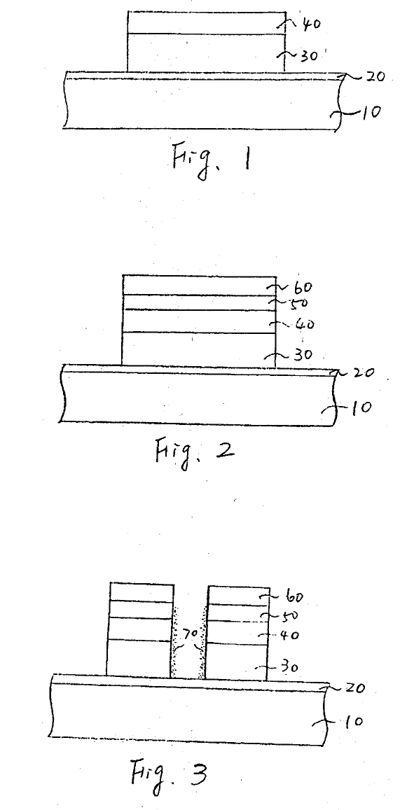

The present invention provides a method for removing polymer formed on surfaces of a gate. FIGS. 1-3 are cross-sectional views of the fabrication steps consistent with one embodiment of the present invention. Referring to FIG. 1, an embodiment of the method of the present invention begins with defining a wafer substrate 10. An insulator 20 is formed over substrate 10. Insulator 20 may be composed of oxides and may be a tunneling oxide. A step for cleaning the surface of insulator 20 may follow to remove undesirable contaminants. A first gate layer 30, which may be comprised of polysilicon, is provided over insulator 20. First gate layer 30 may be deposited over insulator 20 with any conventional process such as chemical-vapor deposition (CVD). A layer of dielectric material 40 is provided over first gate layer 30.

In one embodiment, a layer of photoresist (not shown) is then deposited over dielectric material 40. The layer of photoresist is patterned and defined using a conventional photolithographic process. With the patterned and etched photoresist as a mask, a dry etching process is performed to form a plurality of semiconductor structures including insulator 20 and first gate layer 30. However, unintended by-products may be formed on the sidewalls of first gate layer 30 during the dry etching process due to the presence of organic compounds in the etching gases. The photoresist is then stripped. A cleaning step follows to, among others, remove the unintended and undesirable by-products. Specifically, the by-products may be removed through an oxidation process shown below:

O₃+CₓH_{y}→O₂+C_{z}Hₐ(OH)_{b}

A mixture of deionized water and ozone gas (Dl-O₃) is used to remove the by-products. This is achieved by dipping substrate 10 and the structures formed thereon into deionized water that has been charged with ozone gas. The method of the present invention is therefore able to remove the by-products to achieve an improved cleaning process.

Alternatively, referring to FIG. 2, a second gate layer 50 is provided over dielectric film 40. A photoresist (PR) layer 60 is then provided over second gate layer 50.

Referring to FIG. 3, PR 60 is patterned and defined using a conventional photolithographic process. A step of dry etching is then performed with the patterned and defined PR 60 as a mask to form a plurality of semiconductor structures including insulator 20, first gate layer 30, dielectric film 40, and second gate layer 50. Each semiconductor structure represents one memory cell. In this embodiment, first gate layer 30 is a floating gate, second gate layer 50 is a control gate, and insulator 20 is a tunneling oxide. The various gases used in the etching process include carbon fluoride or carbon chloride organic compounds. As a result, during the dry etching process, however, undesired by-products 70, i.e., polymer, may be formed along the sidewalls of floating gate 30, control gate 50, or both. PR 60 is then stripped and removed.

A cleaning step follows to, among others, remove undesirable by-products 70. Specifically, polymer 70 may be removed through an oxidation process shown below:

O₃+CₓH_{y}→O₂+C_{z}Hₐ(OH)_{b}

In one embodiment, a mixture of deionized water and ozone gas (DI-O₃) is used to remove polymer 70. This is achieved by dipping substrate 10 and the structures formed thereon into deionized water that has been charged with ozone gas. The method of the present invention is therefore able to remove polymer 70 to achieve a better cleaning process compared to conventional cleaning processes.

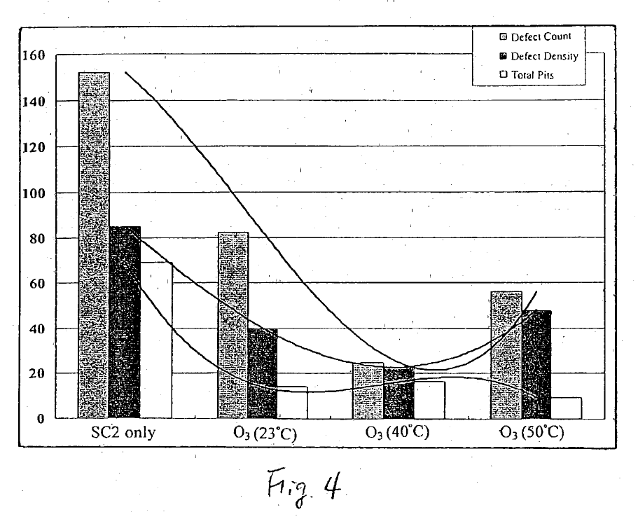

FIG. 4 is a chart comparing the polymer removal capability of a conventional SC-2 cleaning treatment and a cleaning method consistent with one embodiment of the present invention. The polymer removal capability is evaluated in terms of three parameters: defect count, defect density, and the amount of total pits. Higher values of the three parameters represent higher defect levels. Referring to FIG. 4, the DI-O₃ treatment of the present invention at different temperatures exhibits a superior polymer removal capability in comparison with the conventional cleaning process using an SC-2 solution. It is to be understood that to enhance the cleaning effectiveness, the DI-O₃ cleaning method of the present invention can optionally be combined with any conventional cleaning techniques, such as SC-1 and SC-2 treatments.

Conventional semiconductor manufacturing processes may then follow to complete the formation of a memory device and other semiconductor structures.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of manufacturing a semiconductor device, comprising:
providing a wafer substrate;
providing an insulator over the wafer substrate;
depositing a first silicon layer over the insulator;
forming a layer of dielectric material over the first silicon layer;
depositing a second silicon layer over the layer of dielectric material;
providing a photoresist layer over the second silicon layer;
patterning and defining the photoresist layer;
etching the second silicon layer, the layer of dielectric material, the first silicon layer and the insulator unmasked by the photoresist;
removing the photoersist layer; and
cleaning at least the etched first silicon layer with a mixture of deionized water and ozone gas.

2. The method of claim 1, wherein the insulator comprises oxides.

3. The method of claim 1, further comprising cleaning the etched second silicon layer.

4. The method of claim 1, wherein the step of etching comprises dry etching.

5. The method of claim 1, wherein the cleaning step further comprises cleaning with a Standard Clean 1 solution.

6. The method of claim 1, wherein the cleaning step further comprises cleaning with a Standard Clean 2 solution.

7. A method of manufacturing a semiconductor device, comprising:
providing a layer of dielectric material;
depositing a silicon layer over the layer of dielectric material;
providing a photoresist layer over the silicon layer;
patterning and defining the photoresist layer;
etching the silicon layer and the dielectric layer unmasked by the photoresist;
removing the photoersist layer; and
cleaning with a mixture of deionized water and ozone gas.

8. The method of claim 7, wherein the silicon layer comprises polysilicon.

9. The method of claim 7, wherein the silicon layer is a floating gate.

10. The method of claim 7, wherein the silicon layer is a control gate.

11. The method of claim 7, wherein the cleaning step further comprises cleaning with a Standard Clean 1 solution.

12. The method of claim 7, wherein the cleaning step further comprises cleaning with a Standard Clean 2 solution.

13. A method of manufacturing a semiconductor device, comprising:
providing a wafer substrate;
providing an insulator over the wafer substrate;
depositing a silicon layer over the insulator;
forming a layer of dielectric material over the silicon layer;
providing a photoersist layer over the dielectric layer;
patterning and defining the photoresist layer;
etching the silicon layer and the insulator unmasked by the photoresist;
removing the photoresist layer; and
cleaning the etched silicon layer with a mixture of deionized water and ozone gas.
